(19) United States
(12) Patent Application Publication
(10) Pub. No.: US 2024/0098755 A1
(43) Pub. Date: Mar. 21, 2024

(54) METHODS AND SYSTEMS FOR DETERMINING CONTROL MESSAGE FORMAT IN WIRELESS NETWORKS

(71) Applicant: ZTE Corporation, Shenzhen (CN)

(72) Inventors: Jing SHI, Shenzhen (CN); Peng HAO, Shenzhen (CN); Xingguang WEI, Shenzhen (CN); Jian LI, Shenzhen (CN)

(21) Appl. No.: 18/521,291

(22) Filed: Nov. 28, 2023

Related U.S. Application Data
(63) Continuation of application No. PCT/CN2021/128845, filed on Nov. 5, 2021.

(51) Int. Cl. H04W 72/232

(52) U.S. Cl. CPC H04W 72/232

(57) ABSTRACT

Methods and systems for techniques for determining control message formats in wireless networks are disclosed. In an implementation, a method of wireless communication includes determining, by a wireless device, a size of control messages on scheduling cells for which the wireless device is configured to monitor control channels for a scheduled cell, wherein the scheduling cells include a first scheduling cell and a second scheduling cell, and wherein the size of control messages on the first scheduling cell and the size of control messages on the second scheduling cell are same, and monitoring the control channels for the control messages.

### CROSS REFERENCE TO RELATED APPLICATIONS

This patent document is a continuation of and claims benefit of priority to International Patent Application No. PCT/CN2021/128845, filed on Nov. 5, 2021. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for determining control message formats in wireless networks.

In one aspect, a method of data communication is disclosed. The method includes determining, by a wireless device, a size of control messages on scheduling cells for which the wireless device is configured to monitor control channels for a scheduled cell, wherein the scheduling cells include a first scheduling cell and a second scheduling cell, and wherein the size of control messages on the first scheduling cell and the size of control messages on the second scheduling cell are same, and monitoring the control channels for the control messages.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example where PCell is scheduled by itself and SCell, and the SCell is used to schedule the PCell and other SCells.

FIG. 4 shows an example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

For the 5th Generation mobile communication technology, a physical downlink control channel (PDCCH) of P(S)Cell can schedule a physical downlink shared channel (PDSCH) or a physical uplink shared channel (PUSCH) on a secondary cell (SCell), whereas PDSCH or PUSCH on P(S)Cell cannot be scheduled by PDCCH of SCell. The dynamic spectrum sharing (DSS) in NR Rel-16 can lead to limitations on the resources of PDCCH of P(S)Cell. NR PDCCH enhancements for cross-carrier scheduling including PDCCH of SCell scheduling PDSCH or PUSCH on P(S)Cell is introduced to offload the P(S)Cell PDCCH. In some implementations, a downlink control information (DCI) format for scheduling one cell only has one size. When a UE is configured to perform cross-carrier scheduling from SCell to PCell/PSCell, the size of a DCI format on PCell for self-scheduling and the size of the same DCI format on sSCell for cross-carrier scheduling PCell may be different. The disclosed technology can be implemented to determine one size for one DCI format when a UE is configured to perform cross-carrier scheduling from SCell to PCell/PSCell.

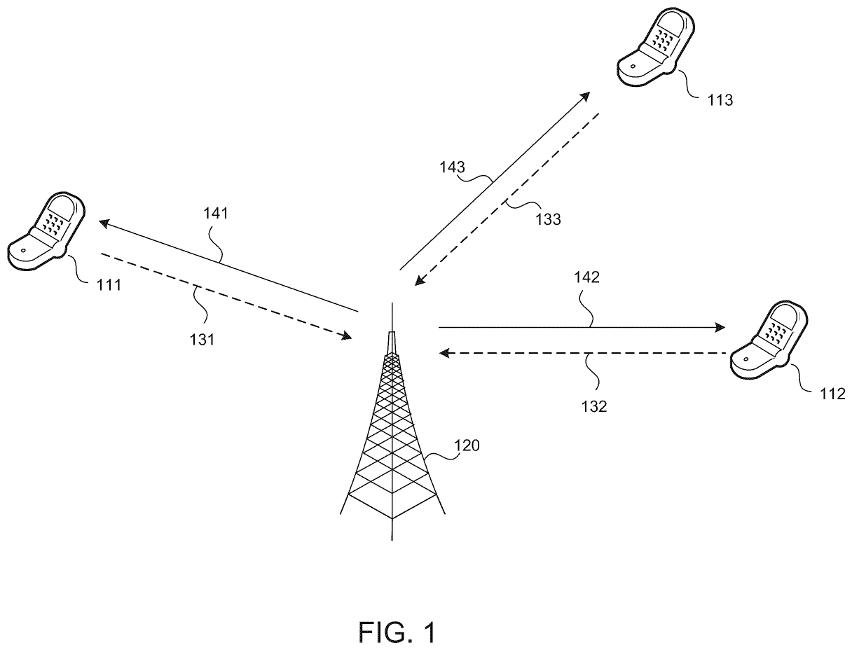

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

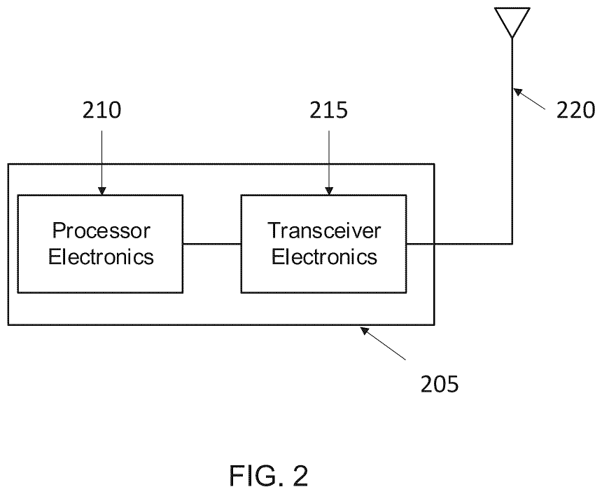

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC). And spectrum used for 4G can be reused for 5G by DSS.

In the current 5G system, a SCell can be either scheduling cell or scheduled cell, while P(S)Cell is a scheduling cell and cannot be a scheduled cell. In a case that P(S)Cell can be both the scheduled cell and the scheduling cell, a DCI format for scheduling one cell only has one size under the current standard. When a UE is configured to perform cross-carrier scheduling from SCell to PCell/PSCell, the size of a DCI format on PCell for self-scheduling and the size of the same DCI format on sSCell for cross-carrier scheduling PCell may be different. The disclosed technology can be implemented to determine one size for one DCI format when a UE is configured to perform cross-carrier scheduling from SCell to PCell/PSCell.

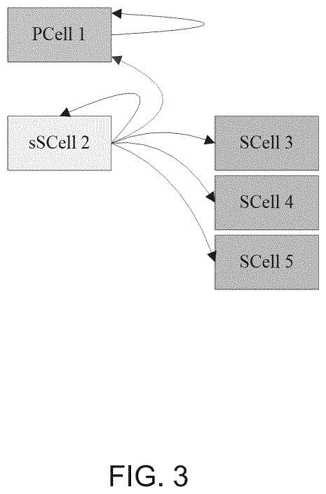

FIG. 3 shows an example where PCell is scheduled by itself and SCell (e.g., sSCell 2), and the SCell (e.g., sSCell 2) is used to schedule the PCell and other SCells (e.g., SCell3, SCell4, SCell5).

### Embodiment 1

In a carrier aggregation scenario, configuring the P(S)Cell (e.g., using PCell as an example) can be scheduled by one SCell (referred to as sSCell to represent the SCell configured for cross-carrier scheduling PCell), and PCell can also support self-scheduling. In a case that the sSCell is configured as a scheduling cell to schedule PCell, the PCell has two scheduling cells, which are PCell and sSCell. In the current 5G system, a DCI format for scheduling one cell (e.g., cell A) has only one size. Each field in the DCI format is determined by a radio resource control (RRC) configuration on the cell A if the field can be configured. When a UE is configured to perform cross-carrier scheduling from SCell to PCell/PSCell, the size of a DCI format on PCell for self-scheduling and the size of the same DCI format on sSCell for cross-carrier scheduling PCell may be different. In some embodiments of the disclosed technology, a carrier indicator field (CIF) is present in the DCI format on PCell for self-scheduling, and CIF is present in the same DCI format on sSCell for cross-carrier scheduling PCell. The number of CIF bits (also referred to as size) in the DCI format on PCell for self-scheduling is same as the CIF in the same DCI format on sSCell for cross-carrier scheduling PCell. Therefore, when a UE is configured to perform cross-carrier scheduling from SCell to PCell/PSCell, only one size is determined for one DCI format.

Take DCI format 1_1 as an example, CIF is present in the DCI format PCell self-scheduling. DCI format 1_1 on P(S)Cell includes the same number of CIF bits as the corresponding DCI format 1_1 on sSCell that is used for P(S)Cell scheduling.

In the current 5G system, the size of the field of SCell dormancy indication is 0 bit if a higher layer parameter dormancyGroupWithinActiveTime is not configured. If the higher layer parameter dormancyGroupWithinActiveTime is configured, 1, 2, 3, 4 or 5 bits bitmap can be determined according to the higher layer parameter dormancyGroupWithinActiveTime, where each bit corresponds to one of the SCell group(s) configured by higher layers parameter dormancyGroupWithinActiveTime, with MSB to LSB of the bitmap corresponding to the first to the last configured SCell group. The field is present only when this format is carried by PDCCH on the primary cell within DRX Active Time and the UE is configured with at least two DL BWPs for an SCell.

In such as case, one size of the DCI format 1_1 should be determined for PCell self-scheduling and sSCell for cross-carrier scheduling PCell, because it is uncertain whether the field of SCell dormancy indication can be in DCI format 1_1 or not.

Method 1: SCell dormancy indication field is present in the DCI format on sSCell only for scheduling PCell, and the size of the SCell dormancy indication field in the DCI format on sSCell only for scheduling PCell is same as the number of SCell dormancy indication bits in the DCI format on PCell that is used for self-scheduling.

For example, the cross-carrier scheduling from SCell to PCell/PSCell is configured, and the size of DCI format 1_1 on PCell for self-scheduling is 60 bits, where the size of the SCell dormancy indication field is 5 bits. SCell dormancy indication field is present in the DCI format on sSCell only for scheduling PCell. Then the size of DCI format 1_1 on sSCell for cross-carrier scheduling PCell is also 60 bits, where the size of the SCell dormancy indication field is 5 bits. It is to be noted that this can be applied to other DCI formats to determine only one size of one DCI format, such as DCI format 1_2, DCI format 0_1, or DCI format 0_2.

Method 2: SCell dormancy indication is not present in the DCI format on PCell that is used for self-scheduling when a UE is configured to perform cross-carrier scheduling from SCell to PCell/PSCell. That means SCell dormancy indication can be present in the DCI format on PCell that is used for self-scheduling when a UE is not configured to perform cross-carrier scheduling from SCell to PCell/PSCell.

For example, the cross-carrier scheduling from SCell to PCell/PSCell is configured, and the size of DCI format 1_1 on PCell for self-scheduling is 50 bits, where the SCell dormancy indication field is not present. SCell dormancy indication field is also not present in the DCI format on sSCell only for scheduling PCell. In such a case, the size of DCI format 1_1 on sSCell for cross-carrier scheduling PCell is also 50 bits, where the SCell dormancy indication field is not present. Therefore, the size of this field is 0 bit, and a higher layer parameter dormancyGroupWithinActiveTime is not configured. It is to be noted that this can be applied to other DCI formats to determine only one size of one DCI format, such as DCI format 1_2, DCI format 0_1, or DCI format 0_2.

In some implementations, non-fallback DCI formats on P(S)Cell include the same number of CIF bits as the corresponding non-fallback DCI formats on sSCell that is used for P(S)Cell scheduling. The value of CIF in the DCI format on PCell for self-scheduling can be one of the following values: (1) CIF=0; (2) the same CIF value is used for P(S)Cell as used by sSCell. For example, CIF value is configured as 3 for P(S)Cell as used by sSCell, CIF is also 3 for PCell as used by PCell that is self-scheduling; and (3) CIF field is reserved. For example, CIF value in DCI format 1_1 is configured as 7 for P(S)Cell as used by sSCell, the size of CIF is 3 bits, then CIF value in DCI format 1_1 for PCell as used for PCell self-scheduling does not need to be determined, and the 3 bits CIF is reserved. The value of CIF can be any one of integer 0-7 or nonnumeric when the CIF is reserved. The value of CIF can vary depending on gNB implementations.

In this way, the disclosed technology can be implemented in some embodiments to determine only one size for one DCI format. The size alignment for one DCI format is not needed, thereby reducing the complexity of the UE implementation and the specification. sSCell can be indicated dormancy state not only by the DCI format on PCell, but also can be indicated by the DCI format on sSCell itself.

### Embodiment 2

In a carrier Aggregation scenario, configuring the P(S)Cell (e.g., using PCell as an example) can be scheduled by one SCell (referred to as sSCell to represent the SCell configured to perform cross-carrier scheduling PCell), and PCell can also support self-scheduling. In a case that the sSCell is configured as a scheduling cell to schedule PCell, the PCell has two scheduling cells, which are PCell and sSCell. In the current 5G system, a DCI format for scheduling one cell (e.g., cell A) has only one size. Each field in the DCI format is determined by the RRC configuration on the cell A if the field can be configured. When a UE is configured to perform cross-carrier scheduling from SCell to PCell/PSCell, the size of a DCI format on PCell for self-scheduling and the size of the same DCI format on sSCell for cross-carrier scheduling PCell may be different. In some embodiments of the disclosed technology, a carrier indicator field (CIF) may or may not be present in the DCI format on PCell for self-scheduling, and CIF is present in the same DCI format on sSCell for cross-carrier scheduling PCell. The number of CIF bits (also referred to as size) in the DCI format on PCell for self-scheduling can be 0 or same as the CIF in the same DCI format on sSCell for cross-carrier scheduling PCell. Therefore, when a UE is configured to perform cross-carrier scheduling from SCell to PCell/PSCell, only one size is determined for one DCI format.

Take DCI format 1_1 as an example, CIF may or may not be present in the DCI format PCell self-scheduling. If CIF is present in the DCI format PCell self-scheduling, DCI format 1_1 on P(S)Cell can include the same number of CIF bits as the corresponding DCI format 1_1 on sSCell that is used for P(S)Cell scheduling or can include the configurable number of CIF bits.

In the current 5G system, the size of the field of SCell dormancy indication is 0 bit if a higher layer parameter dormancyGroupWithinActiveTime is not configured. If the higher layer parameter dormancyGroupWithinActiveTime is configured, 1, 2, 3, 4 or 5 bits bitmap can be determined according to the higher layer parameter dormancyGroupWithinActiveTime, where each bit corresponds to one of the SCell group(s) configured by higher layers parameter dormancyGroupWithinActiveTime, with MSB to LSB of the bitmap corresponding to the first to last configured SCell group. The field is only present when this format is carried by PDCCH on the primary cell within DRX Active Time and the UE is configured with at least two DL BWPs for an SCell.

In such as case, one size of the DCI format 1_1 should be determined for PCell self-scheduling and sSCell for cross-carrier scheduling PCell, because it is uncertain whether a field in DCI format 1_1 is present for both the PCell self-scheduling and the sSCell cross-carrier scheduling PCell, such as SCell dormancy indication, CIF.

Method 1: the size of a DCI format on PCell for self-scheduling and the size of the same DCI format on sSCell for cross-carrier scheduling PCell are aligned when a UE is configured to perform cross-carrier scheduling from SCell to PCell/PSCell. That is, where a UE is configured to perform cross-carrier scheduling from SCell to PCell/PSCell, if the number of information bits in a DCI format in UE-specific search space on PCell/PSCell for self-scheduling is not equal to the number of information bits in the same DCI format in UE-specific search space on the SCell for cross-carrier scheduling PCell/PSCell, a number of zero padding bits are generated for the smaller DCI format until the payload size becomes identical to that of the larger DCI format.

For example, the cross-carrier scheduling from SCell to PCell/PSCell is configured, and the size of DCI format 1_1 on PCell for self-scheduling is 60 bits, where CIF on PCell for self-scheduling is not present, and the size of the SCell dormancy indication field is 5 bits. The size of DCI format 1_1 on sSCell for cross-carrier scheduling PCell is 58 bits, where the size of CIF is 3 bits, and SCell dormancy indication on sSCell for cross-carrier scheduling PCell is not present. In such a case, 2 zero padding bits are generated for the DCI format 1_1 on sSCell for cross-carrier scheduling PCell, and thus the payload size of the DCI format 1_1 on sSCell for cross-carrier scheduling PCell becomes identical to the size of DCI format 1_1 on PCell for self-scheduling, which is both 60 bits. It is to be noted that this can be applied to other DCI formats to determine only one size of one DCI format, such as DCI format 1_2, DCI format 0_1, or DCI format 0_2.

Further, non-fallback DCI formats on P(S)Cell can include the configured or the same number of CIF bits as the corresponding non-fallback DCI formats on sSCell that is used for P(S)Cell scheduling. The value of CIF in the DCI format on PCell for self-scheduling can be one of the following values: (1) CIF=0; (2) the same CIF value for P(S)Cell as used by sSCell. For example, CIF value is configured as 3 for P(S)Cell as used by sSCell, CIF is also 3 for PCell as used by PCell self-scheduling; and (3) CIF field is reserved. For example, CIF value in DCI format 1_1 is configured as 7 for P(S)Cell as used by sSCell, the size of CIF is 3 bits, then CIF value in DCI format 1_1 for PCell as used for PCell self-scheduling is no need to be decided, that means the 3 bits CIF is reserved.

In this way, the disclosed technology can be implemented in some embodiments to determine only one size for one DCI format. The size alignment for one DCI format is needed to cover PCell self-scheduling and sSCell cross-carrier scheduling scenarios while reducing the complexity of the specification. SCell dormancy operation is same as the legacy manner with no additional complexity.

### Embodiment 3

Temporary RS (e.g., aperiodic TRS) is used for SCell activation, which can be used for AGC and for time/frequency tracking. At least two bursts are needed for SCell activation, 1 burst (2-slot with four CSI-RS resources) is required for AGC, 1 separate burst (2-slot with four CSI-RS resources) is required in addition to the one burst required for AGC, which is used for time/frequency tracking. A minimum gap between the RS symbol(s) for AGC and the RS symbols for time/frequency acquisition is needed to account for UE AGC application time delay. For example, the minimum gap is 2 slots for 15 kHz and 30 kHz SCS, and the minimum gap is 3 slots for 60 kHz SCS.

For temporary RS used for SCell activation, A-TRS (any one of the bursts) collision handling with uplink slot/symbols should be resolved.

Method 1: the configured gap value is used, there is a collision with uplink slot/symbols, and there is a fallback to default gap value to receive the second burst. The default value is one of: (1) frame periodicity minus 2 slots; and (2) the minimum periodicity with 2 DL slots minus 2 slots. Here, the configured gap value is a single value which is independent of CSI-RS resources.

For example, the frame structure of the SCell to be activated is “DDUUD DDUUU” numbered slot #0-9, and gap is configured by higher layer signaling is 2 slots. If the first burst is transmitted in slot #0,1, then after 2 slots gap, UE will receive the second burst in slot #4,5, then AGC and time/frequency acquisition can be supported. If the first burst is transmitted in slot #5,6, then after 2 slots gap, collision between the second burst and uplink slot will happen, then the default gap value will be used if the collision would happen, that is using the default gap value to avoid collision between the second burst and uplink slot. After using the default value is (frame periodicity minus 2 slots), Then gNB will sent the second burst in the same two slots in the next frame, and UE will also receive the second burst in the same two slots in the next frame, that is in slot #5,6 in next frame.

Method 2: The gap value is configured independent of CSI-RS resources, and multiple gap values can be configured. In such a case, MAC CE is used only to trigger the 1st burst, and UE attempts the candidates gap values to avoid the collision or uses one of candidate values combined with frame structure (e.g., gap pattern predefined/configured with frame structure).

For example, the frame structure of the SCell to be activated is “DDUUD DDUUU” numbered slot #0-9, and the gap configured by higher layer signaling is {2, 3, 4} slots. Gap pattern is configured as {2, 4, 3} slots for the end slot of the first burst in the slot #1, #5, #6 in one frame. As a result, if the first burst is transmitted in slot #0,1, then after 2 slots gap, UE will receive the second burst in slot #4,5, then AGC and time/frequency acquisition can be supported. If the first burst is transmitted in slot #4,5, then after 4 slots gap, UE will receive the second burst in slot #0,1 in the next frame, then AGC and time/frequency acquisition can be supported. If the first burst is transmitted in slot #5,6, then after 3 slots gap, UE will receive the second burst in slot #0,1 in the next frame, then AGC and time/frequency acquisition can be supported. As such, using the gap pattern can avoid a potential collision between the second burst and uplink slot.

In some implementations, if there are no two consecutive slots indicated as downlink slots by tdd-UL-DL-ConfigurationCommon or tdd-UL-DL-ConfigDedicated, A-TRS based SCell activation cannot be configured/enabled. In some implementations, if multiple gaps can be configured, one value can be used to indicate the second burst is not received. As such, a potential collision between the second burst and uplink slot can be avoided by not transmitting the second burst.

In this way, the disclosed technology can be implemented in some embodiments to use the minimum gap for most cases. In a case of collision with uplink slots/symbols, using default value of the gap can also make SCell activation available, and thus a larger gap is avoided to make all cases of SCell activation available with a larger delay of the SCell activation.

As discussed above, the disclosed technology can be implemented in some embodiments to determine one size for one DCI format when a UE is configured to perform cross-carrier scheduling from SCell to PCell/PSCell.

In some implementations, SCell dormancy indication field is present in the DCI format on sSCell only for scheduling PCell. SCell dormancy indication field has the same number of SCell dormancy indication bits in the DCI format on PCell that is used for self-scheduling.

In some implementations, SCell dormancy indication is not present in the DCI format on PCell that is used for self-scheduling when a UE is configured to perform cross-carrier scheduling from SCell to PCell/PSCell. Thus, SCell dormancy indication can be present in the DCI format on PCell that is used for self-scheduling when a UE is not configured to perform cross-carrier scheduling from SCell to PCell/PSCell.

In some implementations, the size of a DCI format on PCell for self-scheduling and the size of the same DCI format on sSCell for cross-carrier scheduling PCell are aligned when a UE is configured to perform cross-carrier scheduling from SCell to PCell/PSCell.

In some implementations, CIF is zero (0) or the same CIF value as sSCell is used for P(S)Cell, and another alternative is reserved. It is to be noted that non-fallback DCI formats on P(S)Cell include the same number of CIF bits as the corresponding non-fallback DCI formats on sSCell that is used for P(S)Cell scheduling.

The disclosed technology can also be implemented in some embodiments to handle the collision between A-TRS with uplink slot/symbols, in a case of A-TRS based SCell activation.

In some implementations, the configured gap value is used, and there is a collision with uplink slot/symbols, and there is a fallback to default gap value to receive the second burst. The default value is one of: (1) frame periodicity minus 2 slots; and (2) the minimum periodicity with 2 DL slots minus 2 slots. Here, the configured gap value is a single value which is independent of CSI-RS resources.

In some implementations, the gap value is configured independent of CSI-RS resources, and multiple gap values can be configured. In such a case, the disclosed technology can also be implemented in some embodiments to use MAC CE only to trigger the 1st burst, and UE attempts the candidates gap values to avoid the collision, one of candidate values combined with frame structure can be used (e.g., gap pattern predefined/configured with frame structure).

In some implementations, if there are no two consecutive slots indicated as downlink slots by tdd-UL-DL-ConfigurationCommon or tdd-UL-DL-ConfigDedicated, A-TRS based SCell activation cannot be configured/enabled. In some implementations, if multiple gaps can be configured, one the value can be used to indicate the second burst is not received.

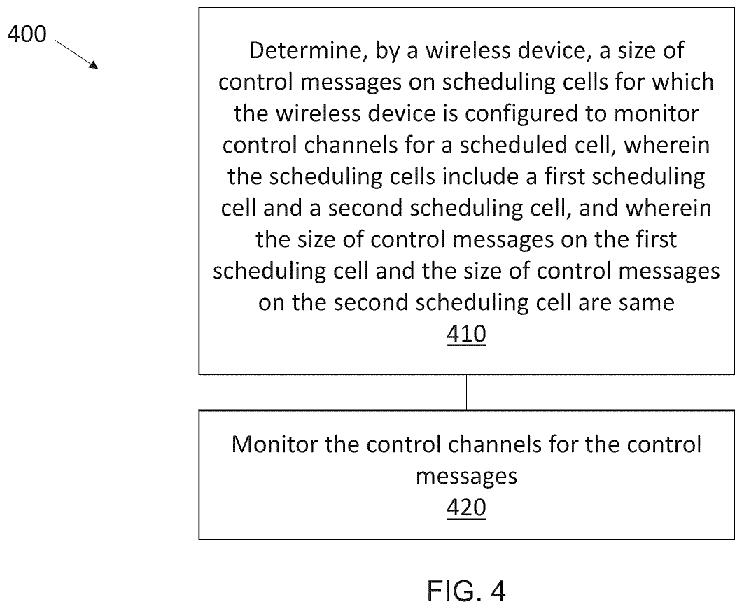

FIG. 4 shows an example of a process for wireless communication based on some example embodiments of the disclosed technology.

In some implementations, the process 400 for wireless communication may include, at 410, determining, by a wireless device, a size of control messages on scheduling cells for which the wireless device is configured to monitor control channels for a scheduled cell, wherein the scheduling cells include a first scheduling cell and a second scheduling cell, and wherein the size of control messages on the first scheduling cell and the size of control messages on the second scheduling cell are same, and at 420 monitoring the control channels for the control messages.

In one example, the messages include a downlink control information (DCI) format. In another example, the first scheduling cell includes a primary cell and the second scheduling cell includes a secondary cell, and the wireless device is configured for scheduling on the primary cell from the primary cell and from the secondary cell. In another example, the primary cell for self-scheduling includes PCell or PSCell, and the secondary cell for cross-carrier scheduling includes sSCell.

It will be appreciated that the present document discloses techniques that can be embodied in various embodiments to determine downlink control information in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of wireless communication, comprising: determining, by a wireless device, a size of control messages on scheduling cells for which the wireless device is configured to monitor control channels for a scheduled cell, wherein the scheduling cells include a first scheduling cell and a second scheduling cell, and wherein the size of control messages on the first scheduling cell and the size of control messages on the second scheduling cell are same; and monitoring the control channels for the control messages.

Clause 2. The method of clause 1, wherein the messages include a downlink control information (DCI) format.

Clause 3. The method of any of clauses 1-2, wherein the first scheduling cell includes a primary cell and the second scheduling cell includes a secondary cell, and wherein the wireless device is configured for scheduling on the primary cell from the primary cell and from the secondary cell.

Clause 4. The method of clause 3, wherein a number of bits of each field in a DCI format on the first scheduling cell for self-scheduling is same as a corresponding field in a same DCI format on the second scheduling cell for cross-carrier scheduling the primary cell.

Clause 5. The method of clause 4, wherein the DCI format on the second scheduling cell for cross-carrier scheduling the primary cell includes an SCell dormancy indication field.

Clause 6. The method of clause 5, wherein a number of bits of the SCell dormancy indication field in the DCI format on the second scheduling cell for cross-carrier scheduling the primary cell is same as the number of bits of the SCell dormancy indication field in the corresponding DCI format on the primary cell for self-scheduling.

Clause 7. The method of clause 5, wherein the SCell dormancy indication field is present in the DCI format on the primary cell for self-scheduling in a case that the wireless device is not configured for scheduling on the primary cell from the primary cell and from a secondary cell.

Clause 8. The method of clause 3, wherein one or more fields in a DCI format on the primary cell for self-scheduling are different from one or more corresponding fields in the same DCI format on the second scheduling cell for cross-carrier scheduling the primary cell.

Clause 9. The method of clause 8, wherein the one or more fields includes a carrier indicator field (CIF), and wherein the CIF is only in the DCI format for scheduling on the primary cell from the second scheduling cell.

Clause 10. The method of clause 8, wherein the one or more fields includes a CIF and a SCell dormancy indication field, and wherein the SCell dormancy indication field is only in the DCI format for scheduling on the primary cell from the primary cell, and the CIF is only in the DCI format for scheduling on the primary cell from the second scheduling cell.

Clause 11. The method of clause 8, wherein a size alignment is performed in a case that the wireless device is configured for scheduling on the primary cell from the primary cell and from a secondary cell, and wherein the number of information bits in a DCI format for scheduling on the primary cell from the primary cell is not equal to the number of information bits in the same DCI format for scheduling on the primary cell from the second scheduling cell.

Clause 12. The method of clause 11, wherein the size alignment includes adding padding bits to the DCI format that has a smaller number of bits to match the size of the DCI format that has a larger number of bits.

Clause 13. The method of any of clauses 1-3, wherein the DCI format for scheduling on the primary cell from the primary cell and second scheduling cell includes a carrier indicator field (CIF).

Clause 14. The method of clause 13, wherein the CIF is reserved only in the DCI format for scheduling on the primary cell from the primary cell.

Clause 15. The method of clause 14, wherein the value of CIF can be any one of integer 0-7 or nonnumeric when the CIF is reserved.

Clause 16. An apparatus for wireless communication comprising a processor that is configured to carry out the method of any of clauses 1 to 15.

Clause 17. A non-transitory computer readable medium having code stored thereon, the code when executed by a processor, causing the processor to implement a method recited in any of clauses 1 to 15.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
determining, by a wireless device, a size of control messages on scheduling cells for which the wireless device is configured to monitor control channels for a scheduled cell, wherein the scheduling cells include a first scheduling cell and a second scheduling cell, and wherein the size of control messages on the first scheduling cell and the size of control messages on the second scheduling cell are same; and
monitoring the control channels for the control messages.

2. The method of claim 1, wherein the messages include a downlink control information (DCI) format.

3. The method of claim 1, wherein the first scheduling cell includes a primary cell and the second scheduling cell includes a secondary cell, and wherein the wireless device is configured for scheduling on the primary cell from the primary cell and from the secondary cell.

4. The method of claim 3, wherein a number of bits of each field in a DCI format on the first scheduling cell for self-scheduling is same as a corresponding field in a same DCI format on the second scheduling cell for cross-carrier scheduling the primary cell.

5. The method of claim 4, wherein the DCI format on the second scheduling cell for cross-carrier scheduling the primary cell includes an SCell dormancy indication field.

6. The method of claim 5, wherein a number of bits of the SCell dormancy indication field in the DCI format on the second scheduling cell for cross-carrier scheduling the primary cell is same as the number of bits of the SCell dormancy indication field in the corresponding DCI format on the primary cell for self-scheduling.

7. The method of claim 5, wherein the SCell dormancy indication field is present in the DCI format on the primary cell for self-scheduling in a case that the wireless device is not configured for scheduling on the primary cell from the primary cell and from a secondary cell.

8. The method of claim 3, wherein one or more fields in a DCI format on the primary cell for self-scheduling are different from one or more corresponding fields in a same DCI format on the second scheduling cell for cross-carrier scheduling the primary cell.

9. The method of claim 8, wherein the one or more fields includes a carrier indicator field (CIF), and wherein the CIF is only in the DCI format for scheduling on the primary cell from the second scheduling cell.

10. The method of claim 8, wherein the one or more fields includes a CIF and a SCell dormancy indication field, and wherein the SCell dormancy indication field is only in the DCI format for scheduling on the primary cell from the primary cell, and the CIF is only in the DCI format for scheduling on the primary cell from the second scheduling cell.

11. The method of claim 8, wherein a size alignment is performed in a case that the wireless device is configured for scheduling on the primary cell from the primary cell and from a secondary cell, and wherein a number of information bits in a DCI format for scheduling on the primary cell from the primary cell is not equal to the number of information bits in the same DCI format for scheduling on the primary cell from the second scheduling cell.

12. The method of claim 11, wherein the size alignment includes adding padding bits to the DCI format that has a smaller number of bits to match the size of the DCI format that has a larger number of bits.

13. The method of claim 3, wherein a DCI format for scheduling on the primary cell from the primary cell and second scheduling cell includes a carrier indicator field (CIF).

14. The method of claim 13, wherein the CIF is reserved only in the DCI format for scheduling on the primary cell from the primary cell.

15. The method of claim 14, wherein a value of CIF can be any one of integer 0-7 or nonnumeric when the CIF is reserved.

16. An apparatus for wireless communication comprising a processor that is configured to carry out a method, comprising:
determining, by a wireless device, a size of control messages on scheduling cells for which the wireless device is configured to monitor control channels for a scheduled cell, wherein the scheduling cells include a first scheduling cell and a second scheduling cell, and wherein the size of control messages on the first scheduling cell and the size of control messages on the second scheduling cell are same; and
monitoring the control channels for the control messages.

17. The apparatus of claim 16, wherein the messages include a downlink control information (DCI) format.

18. The apparatus of claim 16, wherein the first scheduling cell includes a primary cell and the second scheduling cell includes a secondary cell, and wherein the wireless device is configured for scheduling on the primary cell from the primary cell and from the secondary cell.

19. The apparatus of claim 18, wherein a number of bits of each field in a DCI format on the first scheduling cell for self-scheduling is same as a corresponding field in a same DCI format on the second scheduling cell for cross-carrier scheduling the primary cell.

20. The apparatus of claim 18, wherein one or more fields in a DCI format on the primary cell for self-scheduling are different from one or more corresponding fields in a same DCI format on the second scheduling cell for cross-carrier scheduling the primary cell.
